(19) United States
(12) Patent Application Publication
(10) Pub. No.: US 2008/0267145 A1
(43) Pub. Date: Oct. 30, 2008

(54) Methods and Apparatus for Managing Wireless Networks Using Geographical-Level and Site-Level Visualization

(75) Inventor: Mahender Vangati, San Jose, CA (US)

Correspondence Address: INGRASSIA FISHER & LORENZ, P.C., 7010 E. COCHISE ROAD, SCOTTSDALE, AZ, 85253, US

(73) Assignee: SYMBOL TECHNOLOGIES, INC., Holtsville, NY (US)

(21) Appl. No.: 11/741,190

(22) Filed: Apr. 27, 2007

(51) Int. Cl. H04Q 7/24

(52) U.S. Cl. 370/338

(57) ABSTRACT

A WLAN system and method enables network modeling and management through an easy-to-use user interface. A console coupled to the WLAN is configured to display a first set of graphical entities representing locations of the multiple sites in a geographical view, and display a second set of graphical entities in a site view representing a subset of the components selected in response to user input. An XML format may be used to display the various views on a browser operating within the console.

### TECHNICAL FIELD

The present invention generally relates to wireless local area networks (WLANs) and, more particularly, an improved method of managing and visualizing WLAN components in, for example, retail settings.

### BACKGROUND

There has been a dramatic increase in demand for mobile connectivity solutions utilizing various wireless components and wireless local area networks (WLANs). This generally involves the use of wireless access points that communicate with mobile devices using one or more RF channels (e.g., in accordance with one or more of the IEEE 802.11 standards).

The number of mobile units and associated access ports can be very large in an enterprise. Furthermore, an enterprise (e.g., a retail store) may include a number of geographically-dispersed sites, with each site having multiple wireless devices of varying types. Furthermore, such components might be mobile devices with WWAN capability, and may roam outside a site or store location. As the number of components increases, the visualization, management and configuration of such components becomes complicated and time-consuming. Previous solutions generally list devices by name or model in a flat organization structure, a scheme that is not particularly useful for an administrator.

Accordingly, it is desirable to provide improved methods of managing large networks of wireless devices across multiple sites, for example, by visualizing the location of components in a consistent and easy-to-use manner. Other desirable features and characteristics of the present invention will become apparent from the subsequent detailed description and the appended claims, taken in conjunction with the accompanying drawings and the foregoing technical field and background.

### BRIEF DESCRIPTION OF THE DRAWINGS

A more complete understanding of the present invention may be derived by referring to the detailed description and claims when considered in conjunction with the following figures, wherein like reference numbers refer to similar elements throughout the figures.

FIG. 1 depicts an exemplary WLAN architecture useful in describing the present invention;

FIG. 2 depicts an example geographical map in accordance with one embodiment;

FIG. 3 depicts an exemplary site map in accordance with one embodiment; and

FIG. 4 depicts an exemplary coverage gap map in accordance with one embodiment.

### DETAILED DESCRIPTION

The following detailed description is merely illustrative in nature and is not intended to limit the invention or the application and uses of the invention. Furthermore, there is no intention to be bound by any express or implied theory presented in the preceding technical field, background, brief summary or the following detailed description.

The invention may be described herein in terms of functional and/or logical block components and various processing steps. It should be appreciated that such block components may be realized by any number of hardware, software, and/or firmware components configured to perform the specified functions. For example, an embodiment of the invention may employ various integrated circuit components, e.g., radio-frequency (RF) devices, memory elements, digital signal processing elements, logic elements, look-up tables, or the like, which may carry out a variety of functions under the control of one or more microprocessors or other control devices. In addition, those skilled in the art will appreciate that the present invention may be practiced in conjunction with any number of data transmission protocols and that the system described herein is merely one exemplary application for the invention.

For the sake of brevity, conventional techniques related to signal processing, data transmission, signaling, network control, the 802.11 family of specifications, and other functional aspects of WLAN systems (and the individual operating components of the system) may not be described in detail herein. Furthermore, the connecting lines shown in the various figures contained herein are intended to represent example functional relationships and/or physical couplings between the various elements. It should be noted that many alternative or additional functional relationships or physical connections may be present in a practical embodiment.

Without loss of generality, in the illustrated embodiment, many of the functions usually provided by a traditional access point (e.g., network management, wireless configuration, and the like) are concentrated in a corresponding wireless switch. It will be appreciated that the present invention is not so limited, and that the methods and systems described herein may be used in conjunction with traditional access points or any other device that communicates via multiple RF channels.

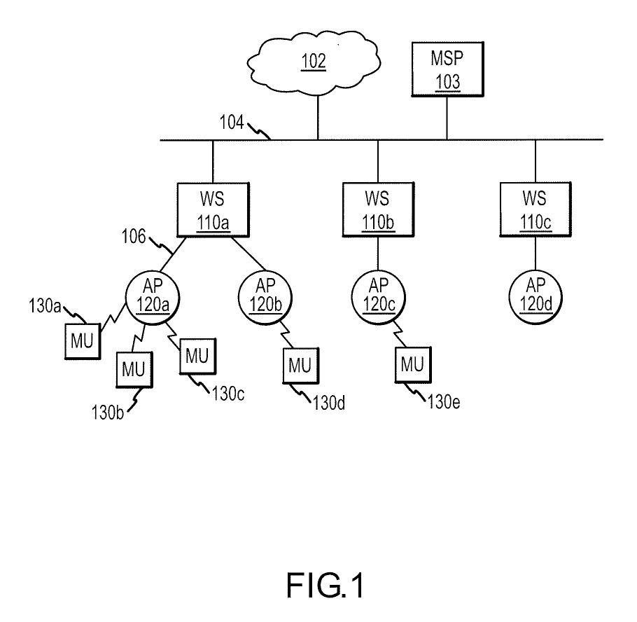

Referring to FIG. 1, which depicts the architecture of an example site, one or more switching devices 110 (alternatively referred to as “wireless switches,” “WS,” or simply “switches”) are coupled to a network 104 (e.g., an Ethernet network coupled to one or more other networks or devices, indicated by network cloud 102). One or more wireless access ports 120 (alternatively referred to as “access ports” or “APs”) are configured to wirelessly connect to one or more mobile units 130 (or “MUs”). APs 120 are suitably connected to corresponding switches 110 via communication lines 106 (e.g., conventional Ethernet lines). Any number of additional and/or intervening switches, routers, servers and other network components may also be present in the system.

A server and/or console system 103 (generally referred to as a “Mobile Services Platform” or simply “MSP”) communicates with the various WLAN components via network 104. As described below, MSP 103 assists with, among other things, monitoring and modeling the WLAN components using a hierarchical organizational scheme. In this regard, MSP 103 may include any suitable combination of hardware, software, displays, CPU's, consoles, servers, databases, and the like. The term “console” as used herein refers to any console (e.g., user interface, computer, etc.) associated with MSP 103.

A particular AP 120 may have a number of associated MUs 130. For example, in the illustrated topology, MUs 130(a), 130(b), and 130(c) are associated with AP 120(a), while MU 130(e) is associated with AP 120(c). Furthermore, one or more APs 120 may be connected to a single switch 110. Thus, as illustrated, AP 120(a) and AP 120(b) are connected to WS 110(a), and AP 120(c) is connected to WS 110(b).

Each WS 110 determines the destination of packets it receives over network 104 and routes that packet to the appropriate AP 120 if the destination is an MU 130 with which the AP is associated. Each WS 110 therefore maintains a routing list of MUs 130 and their associated APs 130. These lists are generated using a suitable packet handling process as is known in the art. Thus, each AP 120 acts primarily as a conduit, sending/receiving RF transmissions via MUs 130, and sending/receiving packets via a network protocol with WS 110.

In accordance with the present invention, the console of MSP 103 enables management of a site (and the various APs, MUs, and WSs of a site) through an easy-to-use interface that provides a single, consistent manner of visualizing the location of networked devices both within a site and outside the site (e.g., roaming). That is, it provides geographic-level views as well as site-level views. Various web-based software tools and standards may be employed, e.g., Macromedia Flash, XML, Javascript, JSP, and the like. Such tools are known in the art, and need not be described herein.

A console associated with MSP 103 displays the requested views responsive to user input, and is capable of displaying geographical maps (i.e., from a high level) as well as store floor plan (or “site”) maps. In this regard, the term “site” as used herein refers to any store, warehouse, or other location that contains a set of network and mobile devices. Thus, the term “site” is not meant to limit the range of possible applications. Furthermore, the network topology and components shown in FIG. 1 are not meant to limit the range of components and architectures with which the present invention may be employed. The methods and systems of the present invention may be used in conjunction with any suitable WLAN structure.

In brief, the present system provides mapping of location information, which includes both geographical location and store floor-plan location. Geographical location allows visualization of individual sites as well as mobile devices that are WWAN-enabled or otherwise trackable geographically. Site location allows visualization of network devices and mobile devices. Coverage information may also be displayed—i.e., network coverage within a site as well as coverage gap.

The user interface is accessed by the user through any networked computer or component that has access to MSP 103. As a result, the present invention substantially reduces the quantity and complexity of the content and dramatically improves the responsiveness of the console.

In a particular web-based XML embodiment, location maps are plotted using graphical entities referred to as “points,” and coverage maps are plotted using “polygons,” where a polygon consists of one or more points. Connectors are used for connecting points, and may be either lines or arcs.

A point is represented by a circle, ellipse, rectangle or an image. A “point” as used herein thus does not necessarily reflect a mathematical “point.” but more accurately describes an area. A point preferably includes only those attributes needed to render itself. As part of this, a point may also include rendering information, such as “color”.

The following XML code represents various ways in which a point may be represented. In a preferred embodiment, a point can only have one of the tags represented below:

```
<point fill=“red”>
      <circle cx=“2312” cy=“4534” r=“30” fill=“red”/>
      <ellipse cx=“300” cy=“150” rx=“200” ry=“80” fill=“red”/>
      <rect rx=“20” ry=“20” width=“250” height=“250” fill=“red”/>
      <image src=“site_sm.gif” x=“30” y=“50”/>
      <geo_circle lattitude=“5.93000” longitude=“10.17000”
      r=“30” fill=“red”/>
      <geo_ellipse lattitude=“5.93000” longitude=“10.17000”
      rx=“200” ry=“80” fill=“red”/>
      <geo_rect lattitude=“5.93000” longitude=“10.17000”
      width=“250” height=“250” fill=“red”/>
      <geo_image lattitude=“5.93000” longitude=“10.17000”
      src=“site_sm.gif”/>
</point>
```

A polygon is represented by more than one point. In one embodiment, the polygon is always closed and the first point is the same as the last point. A polygon is rendered in accordance with the order in which the points are defined in the XML code. A polygon preferably has no other attributes than what is needed to render itself. Any rendering information that is passed into a polygon is preferably “inherited” by the points as well. Any rendering attributes defined at the point itself would overwrite the information provided at the polygon.

The following XML format represents how a polygon may be represented in an exemplary embodiment.

```
<polygon fill=“red”>
      <point>...</point>
      <point>...</point>
      <point>...</point>
</polygon>
```

A connector is used for connecting points, described above. In one embodiment, a connector is associated with only two points, which should not be the same a connector can be either a type “line” or “arc”. The following XML format represents how a connector may be represented in one embodiment.

```
<connector type=”line” fill=“red”>
      <point>...</point>
      <point>...</point>
</connector>
```

A location is used for representing a position of an entity (e.g., a networked device) on a map. In one embodiment, a location has one and only one point defined within it. In addition to the point, the location has other attributes that are specific to the entity that is being rendered. For example, a location may have attributes for “health,” “number of associated devices,” etc. These attributes can be defined based on the requirements for the MSP 103. The following XML format represents how a location tag may be used in an exemplary embodiment:

```
<location id=“ID”>
      <name>MSP Site</name>
      <attributes>
      <type>MSP_SITE</type>
      <hover>US.West.CA.Site123</hover>
      <url>http://www.yahoo.com</url>
      <attributes>
      <point>...</point>
</location>
```

Coverage graphics may be used for representing either network coverage or a coverage gap within a site. In one embodiment, coverage is defined using a single instance of a polygon. In addition to the polygon, the coverage has other attributes that are specific for rendering the data. The following XML format represents how a coverage tag may be used in one embodiment:

```
<coverage id=“ID”>
      <name>Network Coverage</name>
      <attributes>
            <type>MSP_SITE</type>
            <hover>NC for WS2000</hover>
      </attributes>
      <polygon>...</polygon>
</coverage>
```

Map can be used for representing either location-based or coverage-based maps. The maps typically have a background image (representing a 2-dimensional floor plan). In addition, the map may contain a number of coverage or location tags to represent either the location or coverage maps. Also note that a map can, at the same time, contain both the coverage and location tags. The following XML format represents an example on how the map tag can be used:

```
<map id=“ID”>
      <name>US of A</name>
      <dimensions width=“123” height=“456” />
      <position x=“123” y=“123” />
      <image>US.gif</image>
      <zoomLevel>0</zoomLevel>
      <coverage>...</coverage>
      <coverage>...</coverage>
      <coverage>...</coverage>
      <location>...</location>
      <location>...</location>
      <connector>...</connector>
</map>
```

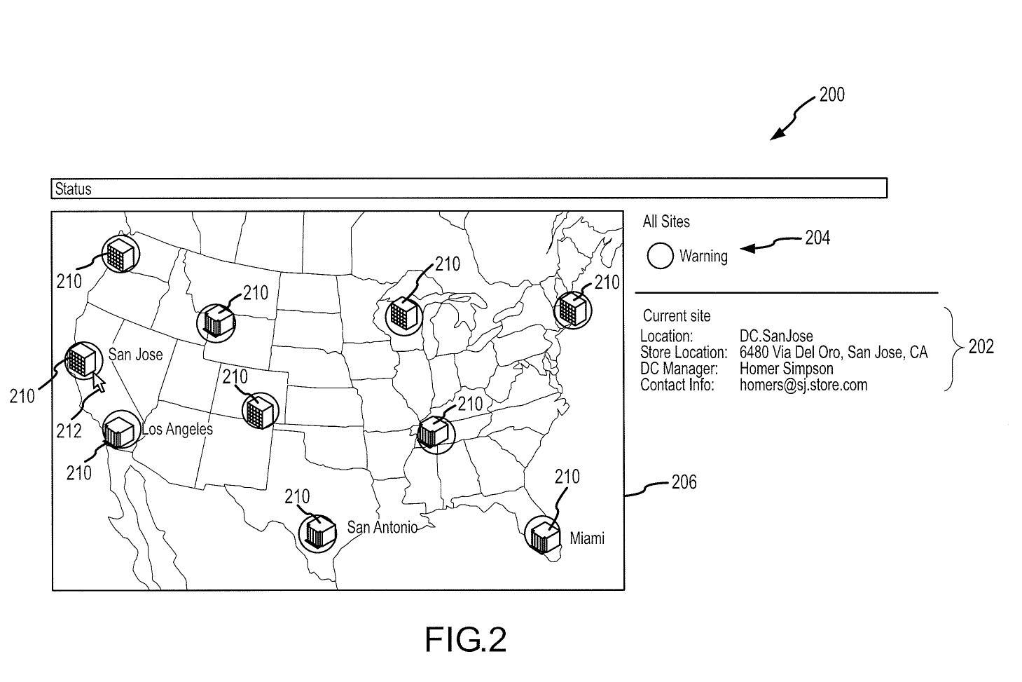

An exemplary geographical map is shown in FIG. 2. As shown, displayed image 200 includes a two-dimensional map image 206 (in this case, a map of the contiguous United States), an information block 202 regarding the “current site,” and a “warning” display 204. A number of sites 210 are superimposed on map image 206, each representing a store or other physical location that is part of the network being managed. In addition, WWWAN mobile devices may also be displayed on this map. A cursor (212) may be manipulated by the user (e.g., using a mouse), to select a particular site 210. In this example, a site labeled “San Jose” is being selected, and the corresponding information regarding this site is displayed in information block 202. The user may then suitably select one of these sites (e.g., via double-clicking), in order to get a close-up view.

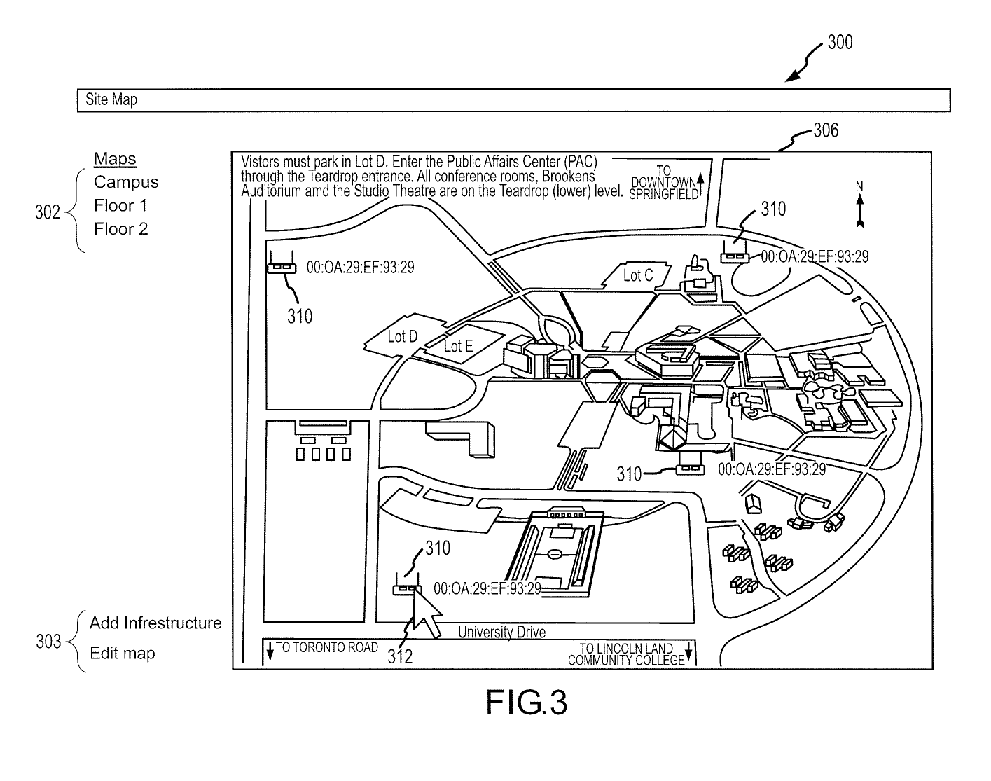

FIG. 3 depicts and exemplary site map, including a two-dimensional map image 306 (in this case, a map of an industrial park), a map selection block 302, an editing block 303, and a number of devices 310 superimposed on map 306. As before, a cursor 312 may be used to select a particular device 310. Certain information, such as MAC or the like, may be displayed on map 306 alongside the image representing each device.

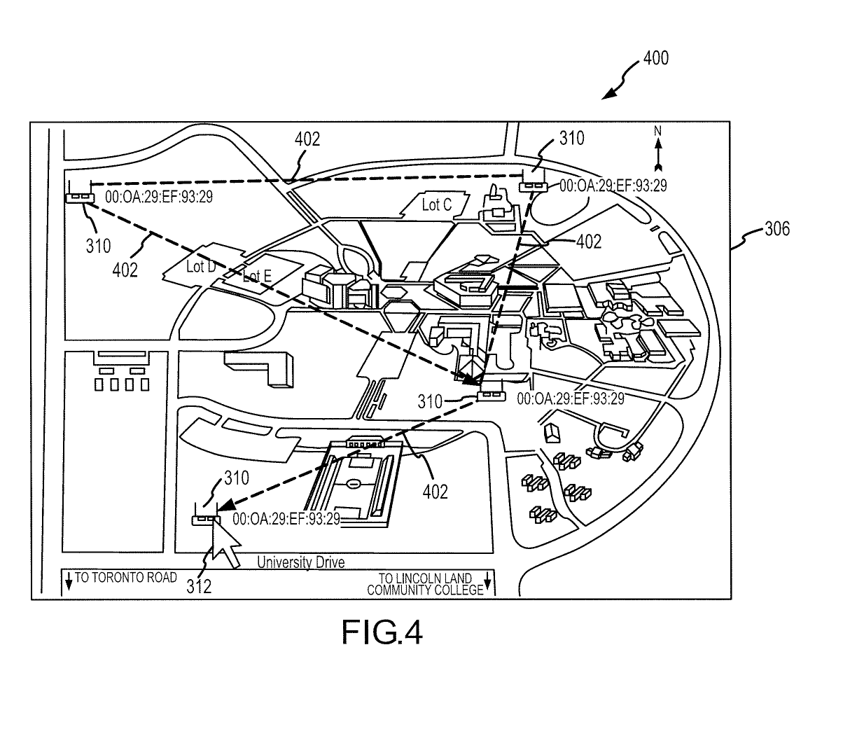

FIG. 4 depicts an exemplary coverage gap map associated with the site map shown in FIG. 3. As shown, a number of connectors 402 (in this case, lines) are used to connect respective devices 310, providing a qualitative view of gaps in wireless coverage.

While at least one example embodiment has been presented in the foregoing detailed description, it should be appreciated that a vast number of variations exist. It should also be appreciated that the example embodiment or embodiments described herein are not intended to limit the scope, applicability, or configuration of the invention in any way. Rather, the foregoing detailed description will provide those skilled in the art with a convenient road map for implementing the described embodiment or embodiments. It should be understood that various changes can be made in the function and arrangement of elements without departing from the scope of the invention and the legal equivalents thereof.

What is claimed is:

1. A method for visually representing components at multiple sites within a wireless local area network (WLAN), the method comprising:
providing a console coupled to the WLAN;
displaying, via the console, a first set of graphical entities representing locations of the multiple sites in a geographical view;
displaying, via the console, a second set of graphical entities in a site view representing a subset of the components selected in response to user input.

2. The method of claim 1, wherein the console includes a web browser, and the displaying steps include utilizing XML code.

3. The method of claim 1, wherein the locations are displayed using points selected from the group consisting of a circle, a rectangle, an ellipse, and an arbitrary image.

4. The method of claim 1, further including displaying, via the console, a coverage map associated with the components, wherein the coverage map includes a polygon.

5. The method of claim 1, wherein the locations are displayed using XML code that includes at least one attribute of the locations.

6. The method of claim 5, wherein the at least one attribute includes the number of the components associated with each of the locations.

7. A system for visually representing components at multiple sites within a wireless local area network (WLAN), the system comprising:
a plurality of network components coupled to the WLAN, the network components including at least one of an access port, a wireless switch, and a mobile unit; and
a console coupled to the WLAN, the console configured to display a first set of graphical entities representing locations of the multiple sites in a geographical view, and to display a second set of graphical entities in a site view representing a subset of the components selected in response to user input.

8. The system of claim 7, wherein the console includes a web browser, and the display is produced utilizing XML code.

9. The system of claim 7, wherein the locations are displayed using points selected from the group consisting of a circle, a rectangle, an ellipse, and an arbitrary image.

10. The system of claim 7, wherein the console is further configured to display a coverage map associated with the components, wherein the coverage map includes a polygon connecting the components.

11. The system of claim 7, wherein the locations are displayed using XML code that includes at least one attribute of the locations.

12. The system of claim 11, wherein the at least one attribute includes the number of the components associated with each of the locations.

13. A console coupled to a wireless local area network (WLAN) of the type including multiple sites, wherein each site includes at least a wireless switch, an access port, and a mobile unit associated with the access port, wherein the console is configured to display a first set of graphical entities representing locations of the multiple sites in a geographical view, and to display a second set of graphical entities in a site view representing a subset of the components selected in response to user input.

14. The console of claim 13, wherein the console includes a web browser, and the first and second set of graphical entities are displayed via XML code.

15. The console of claim 14, wherein the console is further configured to display a third set of entities representing a coverage gap between the components.
